(19) United States
(12) Patent Application Publication
(10) Pub. No.: US 2013/0274936 A1
(43) Pub. Date: Oct. 17, 2013

(54) BROADCAST ENERGY DEMAND SYSTEMS AND METHODS

(71) Applicant: SWAN, LLC, Sparks, NV (US)

(72) Inventors: Paul W. Donahue, Sparks, NV (US); Jeffrey A. Dankworth, Sparks, NV (US); Michel Roger Kamel, Anaheim Hills, CA (US); Ted W. Lanpher, Half Moon Bay, CA (US); Charles E. Rahilly, JR., Toluca Lake, CA (US); Laurence Fish, San Francisco, CA (US)

(73) Assignee: SWAN, LLC, Sparks, NV (US)

(21) Appl. No.: 13/799,594

(22) Filed: Mar. 13, 2013

Related U.S. Application Data
(60) Provisional application No. 61/624,303, filed on Apr. 15, 2012.
(60) Provisional application No. 61/674,506, filed on Jul. 23, 2012.

(51) Int. Cl. G06Q 50/06

(52) U.S. Cl. CPC G06Q 50/06
USPC 700/291

(57) ABSTRACT

A decision support system for energy use demand management manages energy consumption and costs. A one way broadcast communications capability transmits energy management data to a population of energy consumers. A receiver-controller changes the energy consumption of an apparatus in response to receiving the energy management data. An energy consumption monitor determines energy consumption information related, at least in part, to the energy consumption of the apparatus, and provides energy consumption information through a feedback path that can be correlated with the energy management data. The receiver-controller changes the energy consumption of the apparatus in response to an analysis of the energy consumption information.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND

Emergency Alert System (EAS) equipment is in place in television, radio, and cable facilities nationwide and has been used for local weather emergencies for decades. The EAS currently is comprised of analog and digital radio broadcast stations, including AM, FM, and low-power FM stations; analog and digital television (DTV) broadcast stations, including Class A television and low-power TV stations; analog, digital, and wireless cable systems; Direct Broadcast Satellite (DBS) systems, Satellite Digital Audio Radio Systems (SDARS); and other entities.

The present-day EAS is a hierarchical analog message distribution system in which a message originator at the local, state, or national level relays EAS messages from station to station in a problematic “daisy chain” manner. This existing approach to distribution of emergency alerts relies upon retransmission of an alert message from primary broadcasters to secondary broadcasters and then to tertiary broadcasters. This retransmission process introduces significant delay. Moreover, this process generally requires human intervention and in many instances has been found to be a point of breakdown resulting in failure in the distribution of alerts. In many cases the requirement for retransmission is voluntary, and local broadcasters may decide not to transmit an alert due to financial considerations as they may be required to sacrifice commercial time to play an alert.

An additional drawback of existing systems for alert distribution is the inability to target an individual alert to those persons for which that alert is meaningful and not distribute it to those for which it is not relevant. For example, residents of neighborhoods close to the site of an accidental toxic gas release or downwind of the release would need to receive an alert of the event, while residents of areas separated by distance or topography from the point of release may not need to receive the alert.

In the field of energy management, demand response and automated demand response programs and systems have been created to facilitate the reduction in user or demand side loads during periods of energy generation shortage or disruptions in distribution. These systems typically rely on a signal that is sent to a subset of users enrolled in a specific program. Despite significant efforts over the past decade, only a relatively small proportion of commercial and industrial customers are participating in these programs. Many of these systems do not provide adequate information about cause of energy inefficiencies nor do they provide effective energy decision-making information. Moreover, the majority of these participants rely on manual action to initiate demand reduction measures. This human involvement limits the timeliness and extent of reduction levels achieved.

### SUMMARY

Systems and methods to use a digital subcarrier on a terrestrial broadcast station for emergency alerting and information purposes on either wide area multicasting basis or in a geographically targeted or individual receiver narrowcasting mode are provided. Certain embodiments use terrestrial emergency broadcast alerting with digital subcarriers to provide energy supply and load control, information about energy and pricing, energy related “emergencies”, and/or smart grid supply side and demand side energy matching signals.

Embodiments are described that enable the management of energy usage, generation, and/or distribution by addressable control signals that are wirelessly broadcast over FM Broadcast radio stations. The system allows energy management decisions to be guided by either dedicated or cloud-based energy analytic servers and intelligence that incorporate data about energy devices, use, generation, and/or distribution that may include but are not limited to user preferences, current or real time energy pricing, emergency events, brownouts, blackouts, or other factors including utility demand response events, critical peak pricing events, energy load profile characteristics, and/or grid or microgrid faults.

In an embodiment, the system wirelessly broadcasts FM radio subcarrier signals that may include energy pricing information, energy load control, and energy distribution signals that can control one or more of energy routing switches, on/off switches, cycle on and off, set points of systems or subsystems, thermostats, compressors, pumps, electric vehicle charging stations, transformers, and other energy loads and/or generators. Information relevant to energy costs and use of energy loads may be broadcast through the same systems with suggestions and information that enable more effectively enable decision-making control of energy loads through manual, semi-automated, and automatic intervention.

Control signals can be received by and interoperate with any number of customer site end user devices and equipment that can receive and act on, and/or display information about energy use, allowing users to remotely and easily adjust their energy usage, or automatically adjust the use of energy by remotely controlled individual energy loads. Embodiments incorporate soliciting, capturing, and mapping user preferences into a database. Examples of user preferences are, but not limited to, energy usage, energy costs, desired tradeoffs of comfort and economy. The system can utilize such customer preferences to remotely direct a range of options for energy efficiency actions to remotely control energy loads through FM Broadcast control signals.

For communication between the energy management intelligence and user sites, embodiments utilize the wireless broadcasting of FM radio station sub carriers where the FM Broadcast stations has an Effective Radiated Signal power of greater than 10 watts. These broadcast signals possess widespread coverage, high signal strength, and structure penetrating ability, which enable near ubiquitous reception by low cost addressable FM Broadcast subcarrier receivers that have either digital outputs or analog outputs to control individual energy loads and/or to remotely adjust settings of energy load equipment. The system further employs digital encoding of broadcast information and software defined addressing to enable individualized management of multiple location's energy loads, and/or settings on energy loads.

Certain embodiments provide a system to manage energy consumption and costs. The system comprises a receiver configured to obtain energy management data transmitted within a wideband digital subcarrier operating within the licensed frequency spectral mask of a terrestrial wireless VHF broadcasting station, a control module that is configured to change the energy consumption of one or more apparatus in response to receiving the energy management data, and an energy consumption monitor configured to determine energy consumption information related, at least in part, to the energy consumption of the apparatus, where the energy consumption monitor is further configured to provide energy consumption information, and where the control module is further configured to change the energy consumption of the apparatus in response to an analysis of the energy consumption information.

According to some embodiments, a method to manage energy consumption and costs is provided. The method comprises receiving energy management data transmitted within a wideband digital subcarrier operating within the licensed frequency spectral mask of a terrestrial wireless VHF broadcasting station, changing the energy consumption of one or more apparatus in response to receiving the energy management data, determining energy consumption information related, at least in part, to the energy consumption of the apparatus, providing energy consumption information, and changing the energy consumption of the apparatus in response to an analysis of the energy consumption information.

Aspects describe a system to manage energy consumption and costs. The system comprises a receiver configured to obtain energy management data transmitted within a wideband digital subcarrier operating within the licensed frequency spectral mask of a terrestrial wireless VHF broadcasting station, a control module that is configured to change the energy consumption of one or more apparatus in response to receiving the energy management data, and an energy consumption monitor configured to determine energy consumption information related, at least in part, to the energy consumption of the apparatus, where the energy consumption monitor is further configured to provide energy consumption information, and where the transmitted energy management data is based, at least in part, on an analysis of the energy consumption information.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a system to wirelessly distribute addressable energy information data, according to certain embodiments.

FIG. 2 illustrates an exemplary data structure and information for RF transmission of energy information, according to certain embodiments.

FIG. 3 illustrates a system to manage energy, according to certain embodiments.

FIG. 4 illustrates a system to transmit energy control or information signals to energy control devices, according to certain embodiments.

FIG. 5 illustrates an exemplary addressable energy demand response controller, according to certain embodiments.

### DETAILED DESCRIPTION

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

A decision support system for energy use demand management is provided. The system includes a one way broadcast communications capability for transmitting energy management signals to a population of energy consumers, coupled with an independent capability to return energy consumption data that can be correlated with the energy management signals. The system utilizes an FM subcarrier having sufficient bandwidth to selectively and rapidly address a large population of devices.

Past approaches to utilize broadcast signals, such as RDS based systems, have been constrained by limited available bandwidth and due to this limited capacity have been unable to employ more sophisticated addressing schemes that allow more granular and more advanced demand management approaches. The advent of a higher bandwidth system utilizing the addressing capabilities described herein allows the employment of probabilistic management approaches that overcome the drawbacks of conventional deterministic management methods.

Broadcast station subcarrier signals can be used for signaling remotely located and widely dispersed energy controllers including time shifting, on/off, frequency shifting variable speed motor controllers, dimmable light ballasts, and/or energy storage demand side devices that are located throughout the coverage area of a broadcast transmitter and within the service area of an electric or energy utility. Such remotely located and dispersed devices can be controlled by imparting information onto such broadcast transmission subcarriers, including turning on or off one or more frequency tones or subcarriers, imparting a modulation scheme on the main carrier, or imparting analog or digital modulation on the subcarriers of a broadcast station's main earner.

Addressing of individual alerts, information, and device control can be categorized by intended user or group of devices. Addressability can include but is not limited to specific use characteristics such as first responder, local authorities, individuals residing in certain geographic areas, motors, pumps, electric appliances, electric fixtures and to mobile and/or fixed end point receiving devices within a certain GPS defined area, and other parameters.

Filtering of alerts and messages can occur by a variety of means at the endpoint-receiving device. This can take the form of opting-in for desired message categories, opting-out for undesired categories, default settings to define the appropriate types of messages, which should be delivered, or any combination of these approaches.

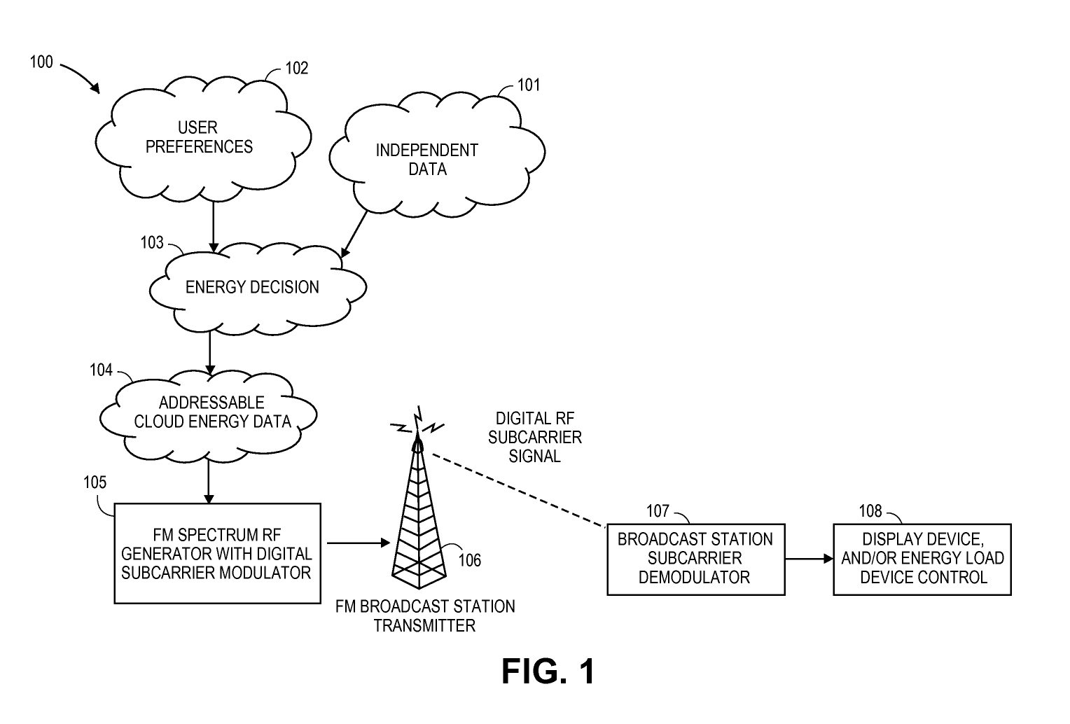

FIG. 1 illustrates a system 100 to wirelessly distribute addressable energy information through a broadcast station subcarrier. In some embodiments, the system 100 utilizes a 1-way wide bandwidth licensed terrestrial very high frequency (VHF) or other broadcast transmission system and is configured to operate in either multicast “one to many” or selective narrowcasting “one to one” energy or “machine to machine” data communications to control devices that are distally located from the transmitter at the local site of energy generating equipment, and/or energy transmission equipment, and/or energy loads.

In other embodiments, the system 100 can be used for “machine to machine” information and device control beyond the field of energy and may include water distribution systems, industrial processes, food processes, and the like.

Typically systems for measurement of end point device or machine actions and the resultant selective wireless dissemination of energy or other “machine to machine” device information and control information would normally use a two way transmission system where the “end point” device receiving information or device control signals is also configured to transmit “return path” information over the same or another communication link.

The benefits of distributing information and device control signals through use of wide bandwidth high powered 1-way VHF or other broadcast stations include but are not limited to overcoming “Firewall” or other incoming data blocking methods and overcoming information and control signal attenuation that can be caused by intervening geography, intervening structures, intervening concrete, brick, and wallboard walls, intervening steel structures, and intervening foliage. In such instances where the use of the wide bandwidth, high powered, 1-way broadcast of information and device control is warranted for reliable outbound communication and device control, no such communication return path normally exists.

The system 100 configures a 1-way broadcast system to behave like a two way communication system where the “return path” communication is an assembly of one or more independent but correlated data inputs that are automatically, intelligently, and dynamically acted upon

The system 100 comprises independent data 101, user preference data 102, an energy decisions module 103, and addressable energy data 104. The energy decision module 103 receives the independent data 101 and the user preference data 102 and provides energy decisions based at least in part on the received independent data 101 and user preference data 102. In an embodiment, the energy decisions module 103 comprises a cloud-based computing system. In another embodiment, the energy decisions module 103 comprises one or more IDSS “Intelligent Data Support System” or “Knowledge based System” that are either “cloud based” or residing on one or more local or distal servers.

The independent data 101 comprises, but is not limited to energy data, energy information, energy management data, or other data related to energy usage. Examples of independent data are interval meter, submeter, or smartmeter data, natural gas data, occupancy sensor data, CO₂ or oxygen sensor data, HVAC system set point data, lighting level data, weather data such as predictive or actual weather patterns, predictive or actual cloud cover, predictive or actual rain, predictive or actual wind patterns, and predictive or actual local environmental conditions, solar irradiance data, other data conditions that are independent but relevant to energy use, automated demand response (ADR) signals signaling from utilities that are to be distributed to their service area users or a subset of their service area users, real time or dynamic energy supply and pricing signals, emergency or other non-emergency information, solar or wind generator output, manual confirmation of actions, automated confirmation of actions, and the like that enable the determination of useful versus wasted energy at a given location.

User preference data 102 comprises information received from user interface devices that present users with choices on energy usage, including preferences for comfort level or temperature levels that may be adjusted relative to information about energy costs, preferences for facility occupancy, preferences for energy pricing, preferences for energy curtailment opportunities, control rules, and the like.

The energy decisions module 103 comprises a data base that includes the independent data 101 and/or user preferences data 102, a modeling element that acts upon data 101, 102 to automatically and dynamically derive or determine actions for groups of devices or single devices, distal from the 1-way VHF broadcast transmission site. The energy decisions module 103 outputs the addressable cloud energy data 104 which comprises energy data decisions addressed to remotely-located addressable devices where information is to be disseminated and/or control of such devices is to occur. Examples of the addressable cloud energy data 104 comprise energy machine control, energy load control, machine process control, energy transmission routing control using Web-based and/or “cloud based” analytical algorithms, and the like.

In an embodiment, the energy decisions module 103 combines knowledge of the energy optimization domain with an inference capability to enable the system to diagnose useful versus wasted energy data from the data 101, 102 and provide outputs 104 that behave approximately like a human consultant. The energy decisions module 103 gathers and analyzes the data 101, 102, identifies and diagnoses problems, proposes possible courses of action and evaluates the proposed actions. In an embodiment, these artificial intelligent techniques embedded in intelligent decision support system of the energy decisions module 103 enable these tasks to be performed by a cloud based or local computer.

In an embodiment, the energy decisions module 103 comprises intelligent computing agents and algorithms that perform complex cognitive tasks without human intervention. In an embodiment, the energy decisions module 103 comprises an active dynamic and/or neural network decision support system “DSS ” for energy modeling where algorithms may be based on selected cognitive decision-making functions and artificial intelligence or intelligent agents technologies that output individual or groups of device control(s) signals, and/or energy information.

The system 100 further comprises an RF generator 105 and a transmitter 106. The RF generator 105 and the transmitter 106 comprise elements of a wideband digital subcarrier and broadcast transmitting station that are operating within the licensed spectral mask of a licensed terrestrial broadcasting station. In an embodiment, the wideband digital subcarrier has a data throughput of at least 16 kbits/second. In another embodiment, the wideband digital subcarrier has a data throughput of at least 12 kbits/second. In an embodiment, the broadcasting station comprises a terrestrial wireless VHF broadcasting station. In another embodiment, the broadcasting station comprises a terrestrial wireless UHF broadcasting station. In an embodiment, the broadcasting station has a licensed transmitting power of at least 100 watts. In another embodiment, the broadcasting station operates with an antenna that is placed at least 500 feet above average surrounding terrain. In an embodiment, the broadcasting station is an analog broadcasting station. In another embodiment, the broadcasting station is a digital broadcasting station.

In an embodiment, the RF generator 105 comprises a FM spectrum RF generator with a digital subcarrier modulator. The energy decision data is sent from the addressable energy data module 104 to the RF generator 105. The RF generator 105 imparts the energy decision data on a subcarrier that modulates the main transmission carrier of a broadcast station. In an embodiment, the broadcast station comprises the transmitter 106.

In some embodiments, the transmitter 106 comprises at least one of an AM medium wave transmitter, FM VHF transmitter, TV VHF or UHF transmitter, digital VHF, UHF microwave transmitter, and satellite broadcast radio frequency transmitter (RF) that delivers approximately greater than 10 watts of power from a main carrier of any bandwidth into any type of transmitting antenna.

In an embodiment, the transmitter 106 comprises an FM VHF transmitter and the addressable energy decision data is transmitted within a wideband digital subcarrier operating within the licensed frequency “spectral mask” of a terrestrial wireless VHF broadcasting station. In an embodiment, the wideband digital subcarrier of licensed terrestrial wireless VHF broadcasting station has a data throughput of at least 16 kbits/second. In a further embodiment, terrestrial wireless VHF broadcasting station has a licensed transmitting power of at least 100 watts. In a yet further embodiment, the terrestrial wireless VHF analog broadcasting station operates with an antenna that is placed at least 500 feet above average surrounding terrain.

The system 100 further comprises a demodulator or receiver-controller 107, and an energy load control device 108. The receiver-controller 107 receives the digital RF subcarrier signal transmitted from the transmitter 106, and demodulates the RF signal to extract the addressable energy data information. In an embodiment, the receiver-controller 107 is individually addressed or addressed as a group through the addressable energy data. The receiver-controller 107, in some embodiments, can output information, device control signals or other signals including audible music and information or display information that can include text, visual or audible alerts and alarms, or other methods for conveying information or control signals to end point users or devices 108.

The demodulated addressable energy data is sent to the energy load control device 108 where it is displayed or used for energy control. In an embodiment, the energy load control devices 108 is individually addressed or addressed as a group through the addressable energy data. When used for energy control, the energy load control devices 108 generate control output signals to control the energy usage of energy using devices. Examples of control output signals are, but not limited to pumps ON/OFF, vacuum fluorescent ballast set points, fans ON/OFF, boilers ON/OFF, temperature set, reheat coils ON/OFF, lights ON/OFF or dim, fountains ON/OFF, whirlpool ON/OFF, pool pumps ON/OFF, equipment ON/OFF, selected thermostat or HVAC chilled water or boiler set points, selected Variable Frequency AC Motor Drivers (VFD) settings, electric vehicle chargers ON/OFF, blink lights or sound alerts, other control of energy generators, transmission systems, or energy load devices, and the like.

In an embodiment, the energy decisions module 103 can also be configured to function as a cooperative IDSS that modifies, completes, or refines energy decision output control signals and information that are passed along as data information and/or device control signaling information 104 for addressable transmission by the modulator 105 and the transmitter 106 to distal wireless receiving devices 107 for display of information or device control by devices 108. The energy decisions module 103 correlates and analyzes the independent data inputs 101 and user preferences 102 send the results of the analysis through the transmission system 105, 106 for validation. In this configuration, the system 100 improves, completes, and refines the control signals from the energy decision module 103. The process of data collection, analysis by modeling algorithm, establishing addressable information and device control, transmission and reception of such information and controls which feedback to the energy decision module as independent data 101 until a consolidated solution is arrived at for any of a variety of energy use conditions and variables.

In an embodiment, the energy decision module 103 establishes an energy use rule base that acts upon incoming data 101, 102. The use of data feedback from the independent but correlated data 101 can be used to validate and check for consistency of the outputs of addressable energy data 104 from the energy decision module 103.

An embodiment of the energy decision module 103 comprises an energy “DSS” and/or “IDSS” system and can be configured as one or more of the following: a data-driven DSS or data-oriented DSS that analyzes independent external energy and environmental data 101 and user preferences 102 using analytic techniques such as one or more of Regression analysis, Linear regression analysis, Discrete choice modeling, Logistic regression analysis, Time series modeling, Multivariate adaptive regression spline modeling, Machine learning, Neural networks, Support vector machines, k-nearest neighbors, and/or Geospatial predictive modeling, to output specific energy information and control signals for addressing individual or group(s) of energy devices 104 to the modulator 105 for transmission by the transmitter 106

In some embodiments, the independent data 101 and the user preference data 102 acted upon by IDSS agents within the energy decision module 103 may be used to provide localized control signaling or information outputs that are either wireless such as 802.11 based or wired using local transmission techniques such as PLC “power line carrier” that are IP or other format based for device communication and control.

In certain embodiments, the outputs of the energy decision module 103 comprise data from which energy DSS “decisions” and/or IDSS “intelligent decisions” are generated and passed along as addressable energy data 104 for assignment to individual or group(s) of receiving devices 107, 108 and are transmitted the transmission system 105, 106. In one embodiment use of localized wireless or wired communication such as from 802.11 or wired PLC power line carrier may be used to avoid congestion on wide area coverage broadcast stations.

In other embodiments, the energy decision module 103 employs Big Data processing techniques such as Hadoop® for processing Big Data from energy and independent data sources.

Individual devices are associated with individual loads or co-located groups of loads that may be connected via local wired or wireless links. The receiver-controller unit 107 associated with each individual load can identify those broadcast transmissions that are intended for its companion load(s). An example of the elements used in the addressing of individual devices or groups of devices is shown in Table 1.

TABLE 1
Device Broadcast Addressing Scheme

```
Device ID
Customer ID
Geographic Location ID
    Region, district,
Grid Location ID
    Substation, Feeder, Transformer, Service Address
Device Class
    Central AC unit, Package unit, Water heater, Thermostat,
    Lighting array, Pool pump, Irrigation pump,
Device Subclass Pumps >10 HP,
Tariff
    C&I TOU, Residential
Random group assignment
Special status codes
```

The device broadcast addressing may comprise one or more of a device ID, a customer ID, a geographic location ID, a grid location ID, a device class, a device subclass, tariff, group assignment, special status codes, and the like. A device ID comprises an identifier associated with an addressable device while a customer ID identifies a specific customer or a group of customers. Examples of the geographic location ID are, but not limited to a regional ID, a district ID, and the like. A grid location ID, for example, may identify the substation, the feeder line, the transformer or the service address. Different device classes may be identified in the address, which identify the device, for example, as a central air conditioning unit, a pump, a water heater, a thermostat, a lighting array, a pool pump, an irrigation pump, or other electrical device consuming energy. Device subclasses identify the energy rating of the identified device.

Examples of different tariffs identified in the device address are not limited to commercial and industrial users, agriculture, small to medium enterprises (SME) and residential tariffs that include energy use tariffs such as Time of Use (TOU) energy tariffs, real time pricing (RTP) energy tariffs, critical peak pricing (CPP) energy tariffs, and the like. For example, there are many rate structures that number in the 100s or more in the US alone. These rate structures are enabled through the new digital smart meter and these tariffs that are so enabled comprise the new reality of energy pricing in the US and around the world where electric energy that was once “cheap and reliable with flat pricing” is becoming “costly, variable penalty based in price, and unreliable due to the high percentage mandates for diurnal and weather related renewables”. Emerging and existing electric energy and natural gas energy pricing tariffs relate to time of energy being used, the time of day that the energy is consumed (mid day summer being the highest price due to widespread HVAC system use), amount of energy used in kilowatt/hours, megawatt/hours, or gigawatt/hours, and speed at which energy is used as expressed in kilowatts/time interval, megawatts/time interval, and gigawatts/time interval.

Random group assignments comprise a common address segment for a group of one or more devices. This enables an energy management command to be broadcast to a randomly selected subset of the total population of devices in a given category. So, for example, during the four successive thirty minute intervals of a two hour period four equal size groups of randomly assigned end point devices could be shut down. Examples of special status codes are, but not limited to a code designating devices that are located in facilities known to be unoccupied during school holidays and a code designating locations that are temporarily excluded from demand reduction measures, and the like.

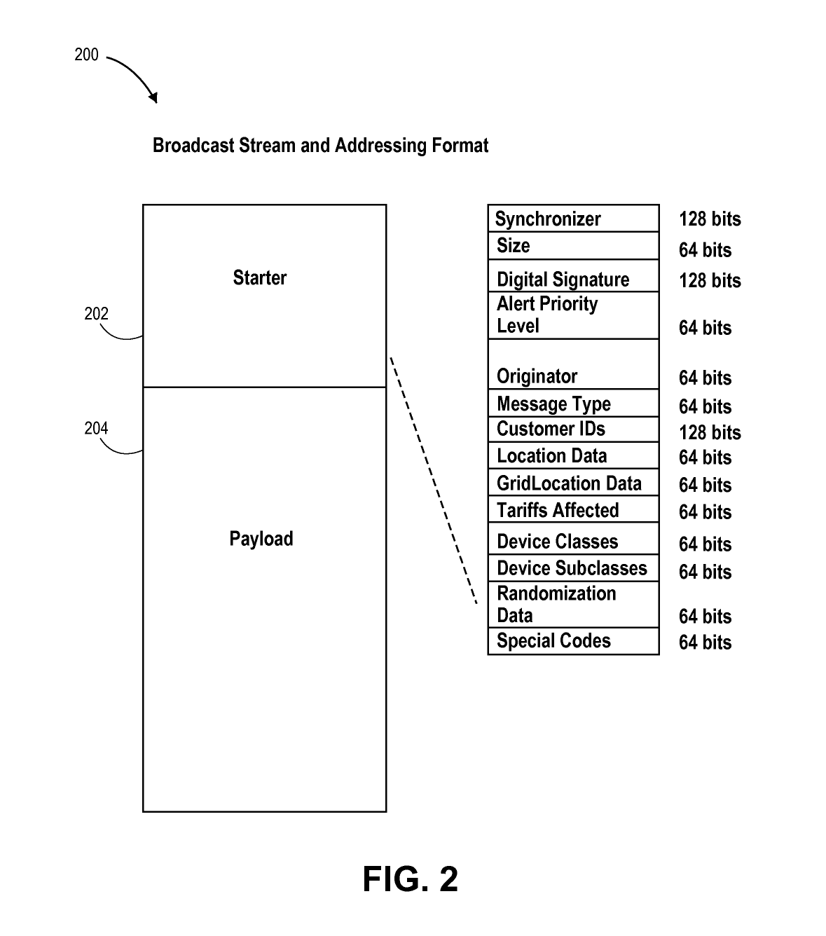

FIG. 2 illustrates an exemplary data format 200 for addressing receiver-controller units in the broadcast stream. The message comprises a starter or header 202 and a payload or message 204. In the illustrated embodiment, the starter comprises a 128 bit synchronizer segment for synchronization with the receiver-controller unit, a 64 bit message size segment indicating the size of the message 204, a 128 bit digital signature identifying the receiver-controller unit, and a 64 bit alert priority segment identify the priority level of an energy alert.

The illustrated starter 202 further comprises a 64 bit originator segment indicating who or what send the message, and a 64 bit message type segment. Examples of message types are a code designating devices that are located in facilities known to be unoccupied during school holidays and a code designating locations that are temporarily excluded from demand reduction measures. The illustrated starter 202 further comprises a 128 bit customer ID segment, a 64 bit location data segment, a 64 bit grid location data segment, and a 64 bit tariff segment. The illustrated starter 202 further comprises a 64 bit device class segment, a 64 bit device subclass segment, a 64 bit randomization data segment, and a 64 bit special code segment. Additional segments could be added and the number of bits for each segment can vary from the example in FIG. 2.

Logic for identifying messages addressed to an individual load typically involves Boolean operators, such as AND, NAND, OR, NOR, for example, that define the combination of location, device type and other factors that describe the intended message recipients.

Broadcast signals may include demand response alerts and demand response event requests and commands, signals used to manage energy usage, signals used to convey future pricing changes or forecasts, current pricing information or consumer advisories, and other management and status information. By using the addressing capacity, such signals can be targeted to any number of endpoints within the broadcast signal shadow. The number of individual endpoint targets for a given message can range from a single endpoint or consumer to the entire population in the coverage area, which could number in the millions.

With existing demand management systems that employ direct load control, during a peak demand event on a hot summer day all devices connected to residential air conditioning units within a given section of the utility grid might be called upon to cycle off compressors for some portion of each hour during a four hour event time window. This would affect all of the residences in the given section each hour of the window.

In contrast, utilizing the addressing capability described herein, it is possible to call on a more discrete subset of air conditioners to cycle back. For example, a randomly selected group representing twenty percent of the controllable device population could be cycled back during the first hour of the event window, then a second and different twenty five percent of devices cycled back during the second hour, then a third and yet different thirty percent subset of devices cycled back during the third hour, and finally a forth and yet different twenty percent of devices cycled back during the final hour. Moreover, these percentage adjustments could be made differently within each subsection of the grid, and could be made differently for differing classes of device, as for example when all pool pumps were cycled back within the time event but the air conditioning cycling was only employed within certain time periods or certain sectors of the grid. Thus lessening the impact of the peak demand event.

An example of the logic using Boolean operators to provide the selective addressing, described in the above example is: Device Class ID <ResidAC> AND GridLocation ID <substationXYZ> AND RandomGroup <1001A>. In other embodiments, other methods of address decoding are used.

The utility of the selective addressing capability described herein is amplified given the ability to monitor actual changes in power consumption occurring within localized sectors of the grid subsequent to broadcast of management signals. Broadcast of signals with selective addressing brings increased granularity of control. This allows finer tuning of demand and lessons the potential for customer discomfort.

The advent of advanced metering infrastructure, included smart meters, interval meters, and sub meters that provide frequent measurement and communication of energy usage, permits the development of analytic algorithms that can determine the sources of energy load consumption and identify sources of unproductive, inefficient, and wasteful energy use and Greenhouse Gas emissions that are related to facility energy usage. Such algorithms also identify system adjustments and remote control actions that can reduce energy costs by avoiding utility peak load or transmission capacity charges and pursuing other energy cost-saving measures.

It is recognized that multiple embodiments can be assembled and utilized from the various components or elements of the system described in this document. It is understood that elements of the described system can operate either individually or with one or more other elements of this system to accomplish a unique method of remotely assessing and controlling energy use, energy loads, adjusting energy loads, and or controlling energy supply side generators, microgrids, or a grid.

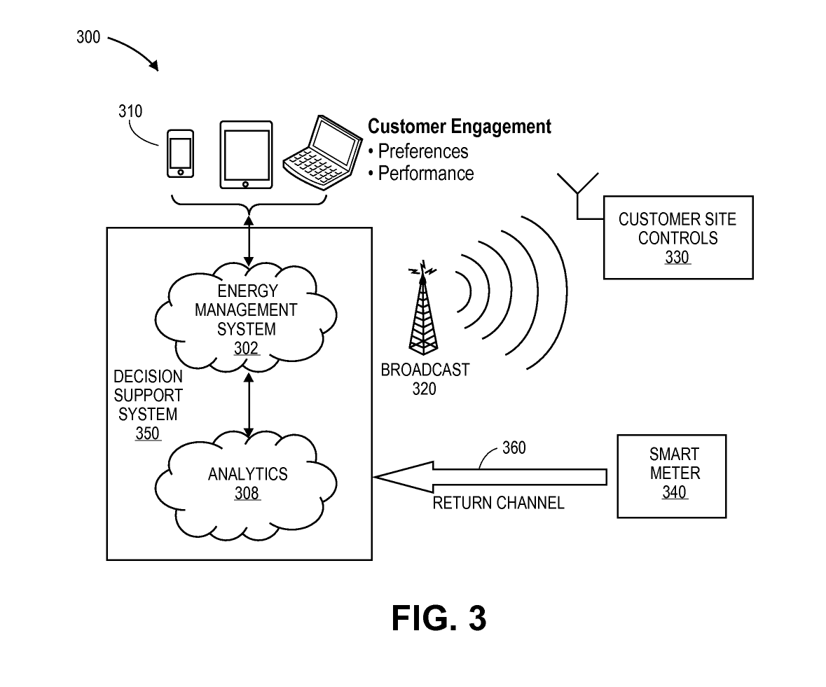

FIG. 3 illustrates a broadcast energy demand and response system 300 comprising customer interfaces 310 for receiving user input, an energy demand support system 350, a broadcast system 320, and control devices 330. The energy decision and support system comprises an energy management system 302 and analytic software or analytics 308.

The customer interfaces 310 present users with choices on energy usage, including preferences for comfort level or temperature levels that may be adjusted relative to information about energy costs and captures user preferences. For residential users this may include lifestyle choices related to heating and cooling, pool pump operation, lighting, operation of appliances, hours or days at home, and the like. For commercial customers, preferences related to heating and cooling profiles, hours of occupancy or operation, timing of equipment operation, system adjustments, participation in demand reduction events, responses to other business, environmental, weather, pricing levels, and the like. Data from the customer interfaces 310 representing customer preferences and inputs is sent to the energy management system 302.

The analytics 308 communicate with utility facilities or third party databases that provide demand response or other energy reduction time data or criteria. The analytic module or analytics 308 of the demand management decision support system 350 described herein contains data representing the historical baseline for addressable sets of loads under varying conditions such as weather. The decision support system 350 can make projections of the aggregate available load that can be shed from differing demand management actions, such actions being implemented via broadcast signals sent to selectively addressable subsets of end point energy consuming devices. Modeling of such alternatives and projections of probable impact across the addressable population of energy users is used to present alternative options for achieving goals of demand management. Data representing the energy information is sent to the energy management system 302.

The intelligence for the energy management and control system 302 can be hosted on a dedicated server or in a cloud based server configuration. In certain embodiments, the energy management system 302 comprises an energy intelligence database and microprocessor.

The database comprises fixed and/or variable information on customer and customer site equipment, subsystems, and system adjustment points and may also include data such as building square footage, building envelope characteristics, construction materials, type and capacity of HVAC and other energy consuming equipment, geographic location, use, typical occupancy, historical energy consumption, weather, environment, gas use, employee loading, equipment loads, lighting loads, solar irradiance, and the like. Also included in the database are informational details of the devices and controllers 330 that can be communicated with via the system 300. The database may also comprise information on fixed or variable utility tariffs that effect time of use or real time energy pricing.

Inputs to the applications software of the energy management system 302 comprise data from the customer interfaces 310 that maps customer inputs and/or preferences, and data from the analytic software 308 that maps detailed energy reduction options. In an embodiment, energy management data comprises one or more of a demand response, an emergency demand response, an economic demand response, and an ancillary demand response.

The energy management system 302 communicates with other components of the system 300. Energy management and control intelligence from the energy management system 302 is provided for transmission to one or more addressable receiving and control devices 330 through FM Broadcast subcarrier signals from the FM broadcast transmission system or other transmission encoding device 320. In an embodiment, the one or more addressable receiving devices 330 comprise a select group of receiving devices 330.

In an embodiment, the transmission encoding device 320 comprises software and hardware that receives addressable digital command, control, and information from other system modules and/or facility owners or operators, and/or utilities and/or third parties and configures this data for broadcast over an FM Broadcast station subcarrier having an Effective Radiated Power of greater than approximately 1 watt. Customer control devices 330 are connected to energy consuming loads or equipment and/or energy monitoring devices.

In some embodiments of the system 300, customer sites may have a return or feedback channel 360 for transmission of information about energy use, environment, occupancy, weather, solar irradiance, natural gas use, and other energy consumption information about the customer site back to the energy management system 302. One example of such a return channel can be data generated by a smart meter 340. In an embodiment, energy consumption information is provided at intervals less than about one hour. In another embodiment, the energy consumption information is provided at intervals less than about fifteen minutes.

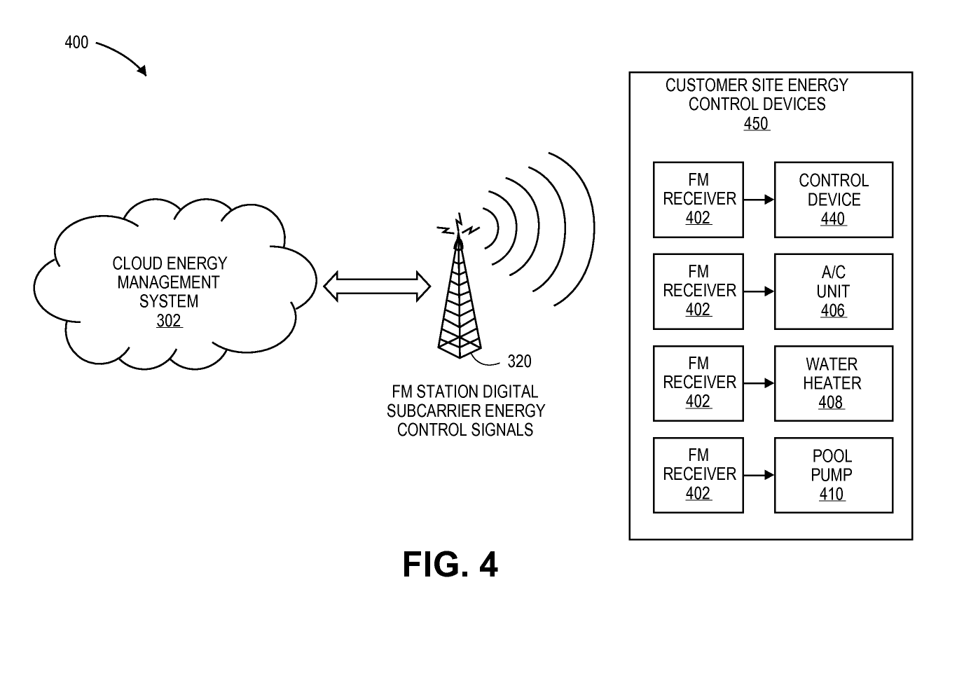

FIG. 4 illustrates a system 400 to transmit energy control or information signals distal energy loads, energy supply sources, micro grids, a smart grid, transformers, and the like. Signals conveying control commands and other information are generated by the energy management system 302 and transmitted by the broadcast system 320 as FM radio signals to a variety of customer site energy control devices 450. In an embodiment, the energy management system 302 comprises a cloud-based or Internet based energy management system 302. In an embodiment, the broadcast system 320 comprises an FM broadcast system 320 transmitting energy management control signals modulated onto a digital subcarrier.

Each customer site device 450 communicates with an FM receiver 402 that receives the broadcast signals. In an embodiment, the customer site energy control devices 450 comprise a receiver 402 and a control device 404-410. In another embodiment, the receiver 402 is separate and distinct from the customer site control device 450 and the control device 404-410. Examples of customer site devices 450 illustrated in FIG. 4 are, but not limited to, air conditioning units 406, water heaters 408, and pool pumps 410. These devices 406, 408, 410 may situated outdoors or inside buildings or other structures. In an embodiment, the receiver-controller is configured to analyze the energy management or energy decision data. In another embodiment, the control device 450, 404-410, is configured to analyze the energy management or energy decision data.

The receiver 402 decodes the digitized subcarrier data and provides local intelligence to the customer site device 450. In an embodiment, the receiver 402 comprises a microprocessor that decodes the digitized subcarrier data. Decoded digitized subcarrier data comprises, by way of example, but not limited to, system or subsystem addressing information, interpretation data, and the like. The control device 404-410 may provide, based at least in part on the decoded data, analog outputs in the form of relays or electronic controls and/or digital outputs to directly control systems, subsystems, or system adjustments through digital I/O signaling.

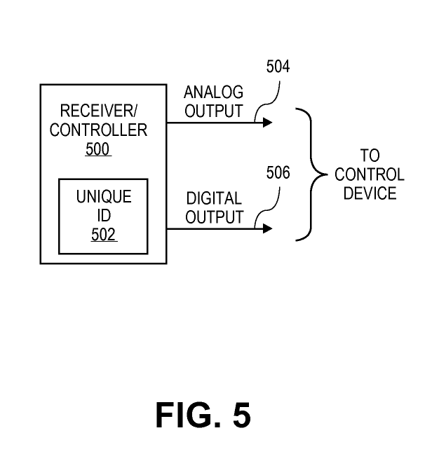

FIG. 5 illustrates an exemplary addressable energy efficiency and demand response receiver/controller 500. In an embodiment, the receiver/controller 500 is an FM Broadcast station receiving device for the purpose of controlling, cycling, or remotely adjusting energy loads, energy supply sources, and/or micro grids, and/or a smart grid, and/or transformers. The receiver/controller 500 can be remotely located on or near a customer site energy control device 450, 404-410. The receiver/controller 500 incorporates intelligence and comprises a microprocessor and firmware or software. The receiver/controller 500 comprises a unique identity 502 can be addressed for signaling and/or controlling devices individually or as a group such, as devices of a predefined type within a given local utility service area. Upon decoding its unique address, the receiver-controller 500 responds to FM broadcast subcarrier signals directed to its address and generates analog outputs 504 or digital outputs 506 that may be used to turn devices or systems on or off, cycle devices or subsystems of devices on or off, and/or control adjustments or set points of energy loads and their systems or subsystems. In an embodiment, the receiver-controller 500 provides energy management data to the energy control devices 450, 404-410 using one or more of Zigbee®, 802.11, TCP/IP LAN, ModBus®, BacNet®, Power Line Carrier®, and the like.

### Other Embodiments

In an embodiment, a portable and mobile network of devices and subsystems operates jointly or separately and comprises wide area distribution of Emergency Alert functionality through use of digital FM subcarriers, and/or Digital TV subcarriers, and/or Digital Cellular systems, and/or Digital Cable broadcasts, and/or Digital Satellite broadcasts, and/or LAN, and/or WAN interactive systems through enabled fixed, and/or portable, and/or mobile devices.

Another embodiment comprises devices, systems of devices, and software including of one or more structured or unstructured databases such as Hadoop® that address and communicate with fixed, and/or portable, and/or mobile devices with Emergency Alert, and/or digital Entertainment, and/or remote device control, and/or digital information. Such cloud based network “traffic director” uses structured, and/or unstructured, and/or relational, and/or non-relational database processing functions and is enabled to address wireless reception enabled fixed, and/or portable, and/or mobile devices. Such device directs the method and Broadcast Station Subcarrier that is used to wirelessly transmit aforementioned information, entertainment, and/or Emergency alerts into such devices through Digital FM subcarrier broadcasts, and/or Digital TV subcarrier broadcasts, and/or Digital Cable broadcasts, and/or Digital Satellite broadcasts, and/or Digital Cellular interactive systems, and/or LAN, and/or WAN interactive systems.

An embodiment comprises Medium Wave AM, and/or VHF FM, and/or VHF/UHF TV Broadcast Station digital subcarrier modulator to impress digitally encoded information and alert signals that include EAS, Homeland Security, Police, Fire, or Utility (DR) information and alerts upon a Broadcast Station RF exciter for wide area wireless distribution and dissemination of information and alert signals where the main RF carrier Broadcast Station transmitting power level is greater than 10 watts.

An embodiment comprises Medium Wave AM, and/or VHF FM, and/or VHF/UHF TV Broadcast Station digital subcarrier modulator to impress digitally encoded information upon a Broadcast Station RF exciter for wide area distribution and dissemination of software programs, books, magazines, news, information, audio, video, and/or equipment firmware updates where the main carrier transmitting power level is greater than 10 watts.

Another embodiment comprises direct individual device reception and subcarrier demodulation of information, entertainment, and/or direct control of devices through AM,FM, TV, Broadcast Station digital broadcast subcarrier signals without the use of intermediary wired or wireless relay points.

Another embodiment comprises localized reception and wireless relay of information, entertainment, and/or control of devices received primarily from AM, FM, TV, satellite digital broadcast subcarrier signals through intermediary wireless Wi-Fi, WiMax, or cellular wireless relay for enhanced local redistribution.

Another embodiment comprises received broadcast subcarrier alerts to initiate receiver actions or control of local devices, systems, or facilities (can include DR).

Another embodiment uses received broadcast subcarrier alerts to provide information and alerts that are suitable for alerting visually handicapped, audibly handicapped or non-English speaking recipients.

Another embodiment comprises local intelligence about facility location, facility operations, facility occupancy, facility energy use, local fire alarms, smoke alarms, lighting levels, CO2 levels, solar power levels, wind speed, EV charging activity, etc. to act as localized gating of controls that can be activated by subcarrier information and alerts that are received from AM, FM, or TV cellular, satellite, Wi-Fi® or WiMax® digital broadcast subcarrier signals broadcast signals.

Another embodiment comprises Geo Centric localized gating on wireless broadcast digital subcarrier receiving device, automobile, portable device, or at facility level network to match specific Geographically targeted EAS or utility DR transmission with targeted device reception.

Another embodiment comprises a multiplicity of alert signals that include inputs from local, regional, or national EAS, Local Police or Fire, or Utility DR alerting using either EAS signaling CAP (common alerting protocols), DTMF signaling, or DRAS or other alerting protocols without limitation.

Another embodiment comprises direct wireless broadcast subcarrier control of dimmers, on/off switches, VFD, or thermostat settings.

A method and system of devices and algorithms that can be used to rapidly dispatch, redirect, or control energy loads based on one or more inputs through wide area wireless FM Broadcast station distribution or through groups of FM Broadcast stations is provided. System, method, and devices that are described herein for illustrative and non-limiting purposes utilize one or more user defined inputs, and/or automated signaling, and/or analytic inputs that map automated addressable device and/or distribution control signals that are conveyed to distal energy controlling devices, loads, load controllers, and/ or energy producing or distributing systems through one or more FM Broadcast Station Sub carriers to meet a multiplicity of requirements that control the state of energy loads, shed energy loads, cycle energy loads, and/or remotely adjust energy load system settings. System can be used to control or redirect the distribution of power generating and power transmission facilities, and/or micro grids, and/or sections of the grid and/or smart grid.

Another embodiment comprises FM Broadcast subcarrier reception device that is software addressable and directly or indirectly controls distal Energy loads.

Another embodiment comprises FM Broadcast sub carrier reception device that is software addressable and digitally connects to either local wired or wireless WiFi®, Zigbee®, or Ethernet® Router for localized and addressable analog relay control or digital control of energy loads or energy load controllers.

Another embodiment comprises a specific control signal sequence that is originated at a server and imparted onto a broadcast station sub carrier specifically in response to a need or desire to control addressable energy loads and/or distribution systems, and/or devices, and/or control energy loads over wide geographic areas in response to specific signaling over FM Broadcast stations to initiate actions to turn loads on or off, cycle energy loads, reset operating parameters or set points of energy loads, redistribute, or shed energy loads.

Another embodiment comprises wide area wireless FM Broadcast transmission of signaling to control the action of geographically dispersed and addressable energy control devices that is based on the prediction of or the measured amount of energy loads being drawn from an energy supply side grid, micro grid, smart grid, or other energy supply distribution network.

Another embodiment comprises wireless control FM Broadcast receiving devices that receive and respond to control signals that are transmitted by an FM broadcast station sub carrier for the purposes of supply side demand energy reduction requirements to prevent overloading of an energy supply side grid, smart grid, micro grid, or natural gas or water pipeline. Demand Response and Automated Demand Response Signals.

Another embodiment comprises wide area geographically dispersed wireless FM Broadcast station sub carrier devices that receive and respond to control signals transmitted by a broadcast station sub carrier for the purposes of demand side energy reduction requirements that emanate from a local or cloud based energy analytic system to prevent excessive use of, excessive cost of, or waste of energy in a facility.

Another embodiment comprises direct wireless broadcast sub carrier communication and control signals for control of dimmers, on/off switches, variable frequency AC motor drivers (VFD), or thermostat settings.

Another embodiment comprises localized real time or near real time (specific) facility environmental conditions that act as automated or manual gating of device, system, or facility control.

Another embodiment comprises remote on/off control of Solar energy producing or wind energy producing systems by Police or Fire officials in case of Fire or other events that affects safe access to facilities where such systems are located or provide power to such facilities.

Another embodiment comprises wide area geographically dispersed wireless control devices that receive and respond to control signals that are transmitted by an FM broadcast station Sub carrier for the purposes of controlling the temperature and/or fan speed settings of individual or a group of thermostats or other controls that are used to control an HVAC, AC system, heat pump, or water heater.

Another embodiment comprises wide area geographically dispersed wireless control devices that receive and respond individually or as a group of energy load controlling devices to FM Broadcast signal control signals or the purposes of controlling individual or a group of lighting control dimmers or lighting on/off switches and/or relays.

Another embodiment comprises wide area geographically dispersed wireless control devices that receive and respond to control signals that are transmitted by a broadcast station sub carrier for the purposes of controlling valves, compressors, air handlers, chillers, and boilers of any type in an HVAC system.

Another embodiment comprises wide area geographically dispersed FM Broadcast wireless control devices that receive and respond to control signals for the purposes of controlling an HVAC system temperature control that heats water for purposes of delivering hot water to hot water reheating coils.

Another embodiment comprises wide area geographically dispersed wireless control devices that receive and respond to control signals that are transmitted by a broadcast station sub carrier for the purposes of controlling the activation of an HVAC system hot water “reheat coil” system and its valves.

Another embodiment comprises wide area geographically dispersed wireless control devices that receive and respond to control signals that are transmitted by a broadcast station sub carrier for the purposes of controlling electric vehicle charging stations.

Another embodiment comprises wide area geographically dispersed wireless control devices that receive and respond to control signals that are transmitted by a broadcast station sub carrier for the purposes of control of battery storage, thermal storage, or other energy storage systems.

Another embodiment comprises wide area geographically dispersed wireless control devices that receive and respond to control signals that are transmitted by a broadcast station sub carrier for the purposes of control of pool or spa water pumps or water heating systems.

Another embodiment comprises wide area geographically dispersed wireless control devices that receive and respond to control signals that are transmitted by a broadcast station sub carrier for the purposes of control of variable speed drives or variable frequency motor controllers.

Depending on the embodiment, certain acts, events, or functions of any of the algorithms described herein can be performed in a different sequence, can be added, merged, or left out all together (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an ASIC, a FPGA or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC.

The above detailed description of certain embodiments is not intended to be exhaustive or to limit the invention to the precise form disclosed above. While specific embodiments of, and examples for, the invention are described above for illustrative purposes, various equivalent modifications are possible within the scope of the invention, as those ordinary skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “proportional to”, as generally used herein, refer to being based at least in part on. The words “coupled” or connected“, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The teachings of the invention provided herein can be applied to other systems, not necessarily the systems described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system to manage energy consumption and costs, comprising:
a receiver configured to obtain energy management data transmitted within a wideband digital subcarrier operating within the licensed frequency spectral mask of a terrestrial wireless VHF broadcasting station;
a control module that is configured to change the energy consumption of one or more apparatus in response to receiving the energy management data; and
an energy consumption monitor configured to determine energy consumption information related, at least in part, to the energy consumption of the apparatus, wherein the energy consumption monitor is further configured to provide energy consumption information;
wherein the control module is further configured to change the energy consumption of the apparatus in response to an analysis of the energy consumption information.

2. The system of claim 1, wherein the wideband digital subcarrier of licensed terrestrial wireless VHF broadcasting station has a data throughput of at least 12 kbits/second.

3. The system of claim 1, wherein the energy management data is based at least in part on the analysis of the energy consumption information.

4. The system of claim 1, wherein the control module is configured to perform the analysis of the energy consumption information.

5. The system of claim 1, wherein the energy management data is targeted to the receiver.

6. The system of claim 5, wherein the broadcast signal comprises identification information associated with the receiver.

7. The system of claim 1, wherein the energy consumption change comprises changing the energy source.

8. The system of claim 1, wherein the energy consumption change comprises changing the amount of energy consumed.

9. The system of claim 8 wherein the energy consumption change comprises one or more of a change of operational points, a change of operational schedule, and a change of operational parameters.

10. A method to manage energy consumption and costs, comprising:
receiving energy management data transmitted within a wideband digital subcarrier operating within the licensed frequency spectral mask of a terrestrial wireless VHF broadcasting station;
changing the energy consumption of one or more apparatus in response to receiving the energy management data;
determining energy consumption information related, at least in part, to the energy consumption of the apparatus;
providing energy consumption information; and
changing the energy consumption of the apparatus in response to an analysis of the energy consumption information.

11. The method of claim 10, wherein the wideband digital subcarrier of licensed terrestrial wireless VHF broadcasting station has a data throughput of at least 12 kbits/second.

12. The method of claim 10, wherein the energy management data comprises user preferences and independent data.

13. The method of claim 12, wherein the user preferences and independent data are based at least in part on the energy consumption information.

14. The method of claim 10, wherein the energy management data comprises one or more of an energy alert, a load control command, energy pricing information, energy consumption information, and environmental information.

15. The method of claim 10, wherein the energy consumption information is provided at intervals less than about one hour.

16. The method of claim 10, wherein the energy consumption information is provided at intervals less than about fifteen minutes.

17. A system to manage energy consumption and costs, comprising:
a receiver configured to obtain energy management data transmitted within a wideband digital subcarrier operating within the licensed frequency spectral mask of a terrestrial wireless VHF broadcasting station;
a control module that is configured to change the energy consumption of one or more apparatus in response to receiving the energy management data; and
an energy consumption monitor configured to determine energy consumption information related, at least in part, to the energy consumption of the apparatus, wherein the energy consumption monitor is further configured to provide energy consumption information;
wherein the transmitted energy management data is based, at least in part, on an analysis of the energy consumption information.

18. The system of claim 17 wherein the transmitted energy management data is further based, at least in part, on user input from a user interface.

19. The system of claim 18 wherein the user input comprises control rules.

20. The system of claim 17, wherein the control module is configured to receive information corresponding to the analysis of the energy consumption information.
